(19) United States
(12) Patent Application Publication
(10) Pub. No.: US 2019/0126839 A1
(43) Pub. Date: May 2, 2019

(54) Bumper Tool Box for Pickup Truck

(71) Applicant: Robert L. Grizzle, Lula, GA (US)

(72) Inventor: Robert L. Grizzle, Lula, GA (US)

(21) Appl. No.: 15/798,962

(22) Filed: Oct. 31, 2017

Related U.S. Application Data
(60) Provisional application No. 62/414,499, filed on Oct. 28, 2016.

(51) Int. Cl. B60R 9/06

(52) U.S. Cl. CPC B60R 9/06

(57) ABSTRACT

A tool box 10 is shaped for mounting to a rearwardly extending tow bar of a pickup truck, with a bottom wall 24 and upwardly extending front, rear and side walls forming an upper opening for containing tools. The container bottom wall 24 extends rearwardly beyond the rear wall 18 and the bottom wall to form a rearwardly facing license plate recess 33 for receiving a vehicle license plate.

Applicant claims priority to Provisional Patent application Ser. No. 62/414,499, filed Nov. 1, 2016.

### BACKGROUND

Generally, pickup trucks are four wheeled land vehicles that have a cab at the front of the vehicle where the driver sits and controls the truck, and a rear “bed” behind the cab for hauling various products.

The bed usually includes a horizontal floor or “bed” positioned behind the cab and side walls extending upwardly from the side edges of the bed. A tailgate is hingedly connected at the rear edge of the bed so that the tailgate may be tilted down from its closed position to an open position to provide access to the bed by a person standing at the rear of the vehicle.

In some cases a tool box is carried in the bed of the pickup truck, usually adjacent the cab where the tool box is out of the way of most of the loads to be carried by the truck and where the tools would be available. In some trucks, the tool box is mounted to the cab or to the bed adjacent the cab and out of the way of most loads to be carried by the truck.

While this conventional arrangement of pickup trucks has been widely accepted as the optimum arrangement and position of a tool box, the driver of the pickup truck or other person usually must climb over the tailgate or over a side wall of the bed and onto the bed to have access to the tool box. Or the driver or another person would have to open the tailgate and climb onto the bed and move forwardly on the bed to the tool box.

### SUMMARY OF THE INVENTION

Briefly described, this invention comprises a truck tool box that may be mounted to the rear of a pickup truck and similar vehicles. The truck tool box is mounted out of the bed of the truck so that it is accessible without requiring the driver to move onto the bed of the truck.

Many pickup trucks are designed to include a standard longitudinally extending pull bar that is mounted to the frame of the truck and that extends rearwardly of the truck and at a level usually lower than the level of the bed of the truck so that a trailer hitch can be connected to the pull bar and trailers may be connected to the trailer hitch and trail behind the truck. This provides a means for connecting boat trailers and various other wheel mounted towed trailers and other items to be pulled behind the truck.

This invention concerns a tool box that may be securely but releasably mountable to a typical tool bar of a typical pickup truck, behind the bed of the truck and at a height usually below the tailgate of the truck when the tailgate is tilted away from the bed of the pickup truck.

### BRIEF DESCRIPTION OF THE DRAWINGS

FIG. 1 is a perspective view of the truck bumper tool box with its lid open and its mounting bars extended to illustrate how the tool box is to be supported by a pull bar of a pickup truck.

FIG. 2 is a side view of the tool box of FIG. 1 with its lid closed.

FIG. 3 is a perspective view of the lower external surfaces of the tool box and shows how a conventional vehicle license plate can be mounted to the tool box.

FIG. 4 is a side view of a typical pickup truck and of the bumper tool box, with a boat trailer and its boat connected to the pull bar that supports the truck bumper tool box.

### DETAILED DESCRIPTION

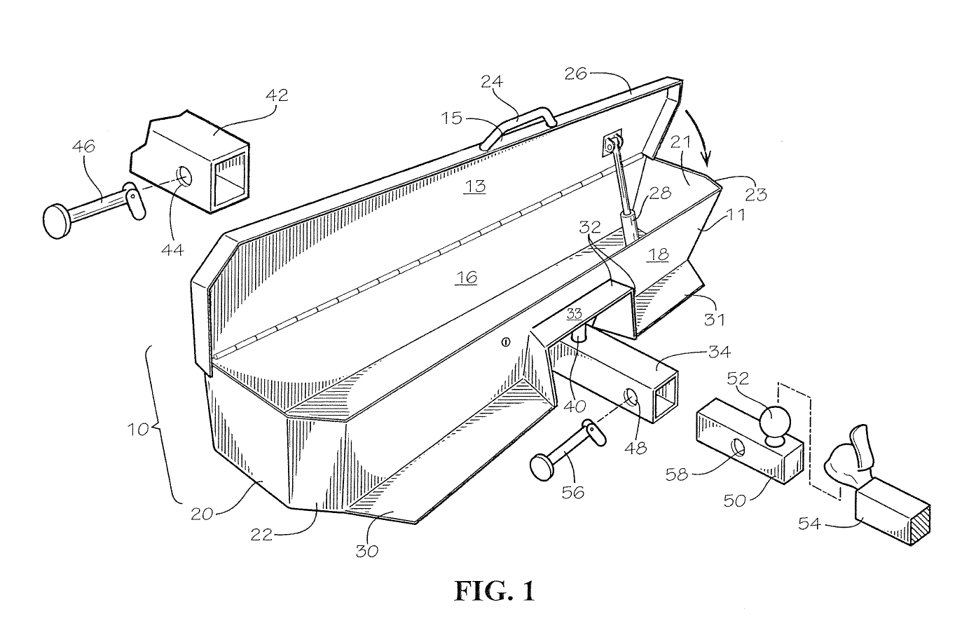

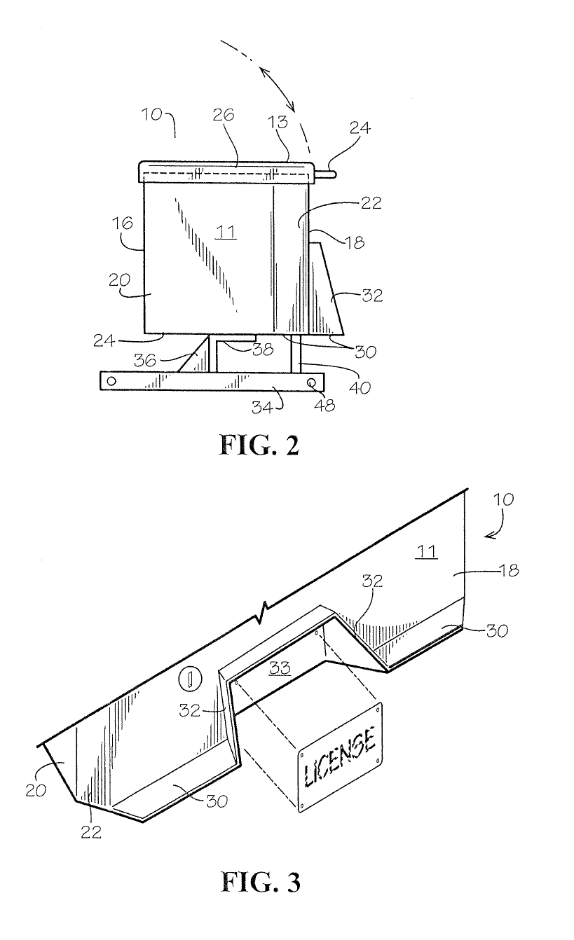

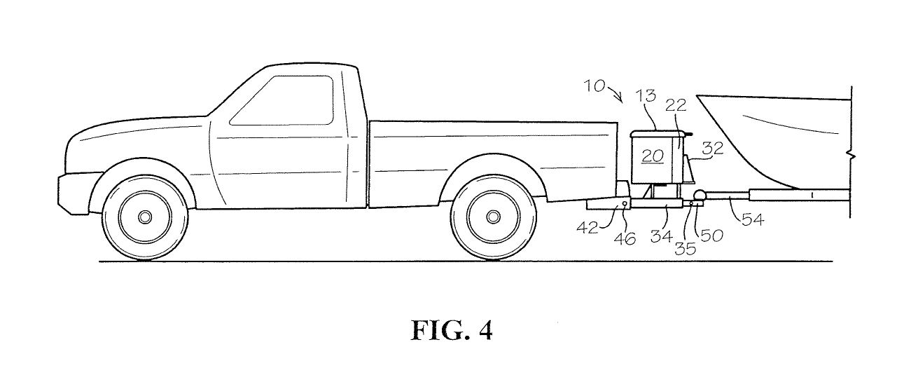

Referring in more detail to the drawings, in which like numerals designate like parts throughout the several views, FIGS. 1 and 2 illustrate a tool box 10 that comprises a container box 11 and the container lid 13, with a hinge 15 pivotally mounting the lid 13 to the container box 11.

The container 11 box includes a front wall 16 that is to face the pickup truck, a rear wall 18 that is parallel to and spaced from the front wall 16, and side walls 20 and 21 that connect the rear wall 18 to the front wall 16, with beveled corners 22 and 23 at the junctions between the side walls and the rear wall 18. The container lid 13 includes a perimeter rim 26 that is shaped to telescope about the upper edges of the rear wall, beveled corners, and side walls when tilted downwardly about the hinge 15 to its closed position shown in FIG. 2. When closed as shown in FIG. 2, the container lid 13 and its perimeter rim close about the upper rim of the container box 11.

A damper 28 shown in FIG. 1 may be mounted between the container box 11 and the container lid 13 so as to absorb the forces of the container lid 13 as it is tilted about its hinge 15 toward and away from engagement with the upper edges of the side walls 20 and 21, as shown in FIG. 2.

The container box also includes a bottom wall 24 which has horizontal extensions 30 and 31 that extend rearwardly beyond the rear wall 18. An apron 32 is mounted to the rear wall 18 and to the horizontal extensions 30 and 31. This forms a rearwardly facing license plate recess 33 of the size and shape of a typical automobile license plate, for receiving a license plate as shown in FIG. 3.

As shown in FIGS. 1 and 2, the container box 11 is mounted on a horizontally extending support bar 34. The support bar may be square in cross section and support members 36, 38 and 40 are fastened between the support bar and the bottom wall 24. Support web 36 may be triangular in shape, support member 38 may be L-shaped, and support member 40 may be bar-shaped. Other shapes may be used as may be appropriate. The support members rigidly support the tool box on the horizontal support bar 34.

As shown in FIG. 1, the tool box 10 will be mounted to the towing vehicle, such as a pickup truck, by telescopically inserting the horizontal support bar 34 into the typical trailer tow bar 42. The tow bar 42 will have laterally extending side lock openings 44 and the horizontal support bar 34 of the tool box 10 is dimensioned so as to be telescopically received within the tow bar 42. Horizontal openings 44 are formed in the vehicle connector bar 42 and a conventional lock pin 46 is to be inserted through the aligned lock openings of the connector bar and the lock openings 49 in the horizontal support bar of the tool box. This locks the tool box in a firm upright position behind the pickup truck or other towing vehicle.

In some instances, the owner of the vehicle and the tool box that is mounted to the vehicle will be in position, when it is desired, for the towing vehicle to pull a trailer behind the tool box. For this purpose, the horizontal support bar 34 on which the tool box is mounted is formed with a pair of aligned horizontal tool box lock openings 48 that may be aligned with a trailer tow bar 50 and extend rearwardly from the tool box. The trailer tow bar 50 may be of a reduced size to fit into the opening of the support bar and include a typical ball hitch 52 onto which a trailer hitch 54 of a trailer may be mounted. The trailer tow bar 50 will have a shape that fits to be telescopically received in the opening of the horizontal support bar 34 of the container box 11, and a conventional lock pin 56 may be inserted through the aligned openings 48 and 58, as shown in FIG. 1, for the purpose of locking the ball hitch 52 in place on the horizontal support bar 34.

When the container lid 13 is closed over the container box 11 as shown in FIG. 2, the container lid rests in a horizontal attitude and forms a step platform for a person attempting to climb over the closed tailgate at the rear of the truck. The upper surface of the container lid may be formed with a tread 70 or have a tread applied thereto. The tread may include an array of upwardly extending protrusions that reduce the likelihood of a person's shoe slipping on the lid as the person uses the step to climb over the tailgate.

Although a preferred embodiment of the invention has been disclosed in detail herein, variations and modifications of the disclosed embodiment can be made without departing from the spirit and scope of the invention as set forth in the following claims.

1. A tool box for mounting to a tow bar of a pickup truck, comprising
a container defining a bottom wall, a front wall extending upwardly from the bottom wall for facing the pickup truck, a rear wall extending upwardly from the bottom wall and spaced from the front wall, and side walls joined to the front wall and the rear wall and the bottom wall, with the bottom wall, front wall, rear wall and side walls defining a chamber with an upper opening for containing tools,
a lid hingedly mounted to the rear wall of the container for selectively closing and opening the chamber,
said container bottom wall extending rearwardly beyond the rear wall and forming a pair of bottom wall extensions, and
an apron extending from the rear wall and between the bottom wall extensions and sized and shaped to form a rearwardly facing license plate recess for receiving a license plate.

2. The tool box of claim 1, and wherein a dampener is mounted between the bottom wall and the lid.

3. The tool box of claim 1, and further including a horizontal support bar mounted to the bottom wall and sized to telescopically fit with the tow bar of a pickup truck.

4. The tool box of claim 1, and further comprising a trailer ball hitch telescopically mounted to the horizontal support bar.

5. The tool box of claim 1, and wherein the bottom wall is coextensive with the apron.

6. A tool box for mounting to a tow bar of a pickup truck, comprising
a container defining a bottom wall, a front wall extending upwardly from the bottom wall for facing the pickup truck, a rear wall extending upwardly from the bottom wall and spaced from the front wall, and side walls joined to the front wall and the rear wall and the bottom wall, with the bottom wall, front wall, rear wall and side walls defining a chamber with an upper opening for containing tools,
a lid hingedly mounted to the front wall of the container for selectively closing and opening the upper opening of the chamber,
said container bottom wall extending rearwardly beyond the rear wall and forming an exterior bottom wall extension, and
an apron extending upwardly from the exterior bottom wall extension and sized and shaped to form a rearwardly facing license plate recess for receiving a vehicle license plate.

7. The tool box of claim 6, and wherein the bottom wall extension comprises a pair of bottom wall extensions spaced from each other and the apron extending upwardly from the pair of bottom wall extensions.
